(19) United States
(12) Patent Application Publication
(10) Pub. No.: US 2015/0089767 A1
(43) Pub. Date: Apr. 2, 2015

(54) CLEANING DEVICE EMPLOYING AIR UNDER PRESSURE

(71) Applicants: FU DING ELECTRONICAL TECHNOLOGY (JIASHAN) CO.,LTD., Zhejiang (CN); HON HAI PRECISION INDUSTRY CO., LTD., New Taipei (TW)

(72) Inventors: DAO-PING KAN, Jiashan (CN); XING-WU WANG, Jiashan (CN)

(21) Appl. No.: 14/480,885

(22) Filed: Sep. 9, 2014

(30) Foreign Application Priority Data
Sep. 27, 2013 (CN) 2013104484127

(51) Int. Cl. B08B 5/02

(52) U.S. Cl. CPC B08B 5/023
USPC 15/318.1

(57) ABSTRACT

Cleaning device employing air under pressure is coupled to an external air source and cleans workpieces being carried. The cleaning device includes a mounting base, an air conduit, and a controller. The air conduit and the controller are mounted on the mounting base. The mounting base defines an air inlet communicating with the air conduit, and a free end of the air conduit is facing the workpiece. The controller is capable of sealing the air inlet and turning on and turning off the air conduit. The free end of the air conduit is designed and made of such material that the conduit swings across the moving workpieces to enable the air flow to blow metal chips and all other contaminants from the surfaces of the workpieces.

### FIELD

The present disclosure relates to cleaning devices, and particularly to air-powered cleaning devices.

### BACKGROUND

In a machining process, contaminants such as cut chips or coolant can be generated and adhere to a workpiece, a fixture, or a carrier. In order to provide a clean machining environment, the contaminants should be cleared. When removing the contaminants, a high-pressure air flow can be used to blow away and remove the contaminants. Thus, when the workpiece is carried by a conveyer out from a machining environment, an air conduit with an air outlet can be held by hand, and the air outlet placed against the workpiece. Air can be blown through the air conduit to the workpiece. The air conduit and the air outlet can be swung by hand to remove the contaminants adhering on the workpiece.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is a front elevational view of an embodiment of a cleaning device employing air under pressure.

FIG. 2 is a left-side elevational view of the cleaning device of FIG. 1.

### DETAILED DESCRIPTION

The disclosure is illustrated by way of example and not by way of limitation in the figures of the accompanying drawings in which like references numerals indicate similar elements. It should be noted that references to “an” or “one” embodiment in this disclosure are not necessarily to the same embodiment, and such references mean “at least one.”

A definition that is applied throughout this disclosure is: the term “coupled” is defined as being connected, whether directly or indirectly through intervening components, and is not necessarily limited to physical connections. The connection can be such that the objects are permanently connected or releasably connected.

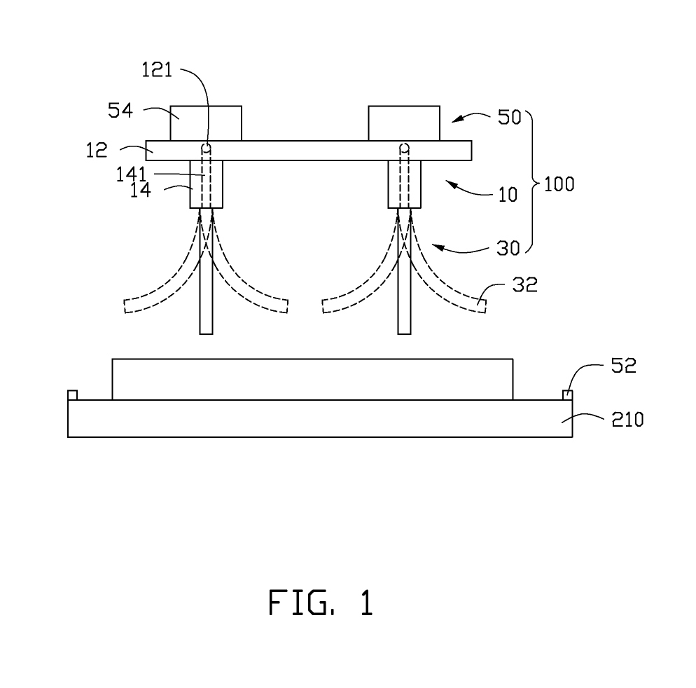

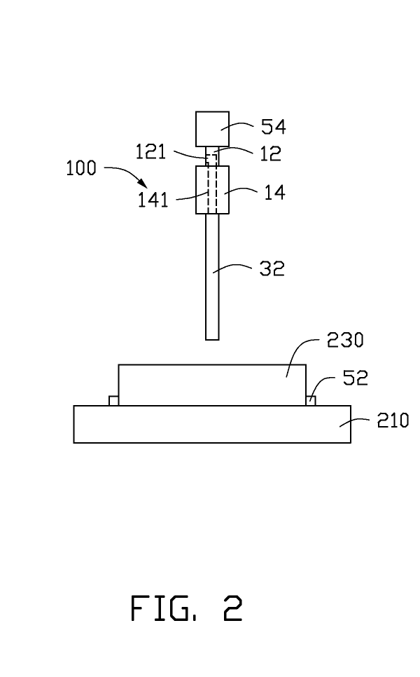

FIGS. 1 and 2 illustrate an embodiment of a cleaning device 100 employing air under pressure, for removing contaminants such as, but not limited to, machined scraps and coolant adhered on a workpiece 230 away from the workpiece 230, as the workpiece 230 is conveyed by a conveyer 210. The cleaning device 100 can include a mounting base 10, an air conduit 30, and a controller 50. The air conduit 30 and the controller 50 can be mounted to the mounting base 10.

The mounting base 10 can include a supporting member 12 and a mounting member 14 positioned on the supporting member 12. The supporting member 12 can define an air inlet 121 for communicating with an external air source (not shown). The mounting member 14 can be substantially a hollow structure, and can define an inner cavity 141. The inner cavity 141 of the mounting member 14 can communicate with the air inlet 121. In at least one embodiment, the mounting base 10 can be equipped with two mounting members 14. The two mounting members 14 can be spaced from each other and mounted on the supporting member 12.

An end of the air conduit 30 can be coupled to the mounting member 14, the other end of the air conduit 30 can be a free end 32 capable of swinging/vibrating/oscillating/waving freely. The air conduit 30 can communicate with the external air source through the inner cavity 141 and the air inlet 121 of the mounting member 14. The air conduit 30 can be arranged along a vertical axis because of gravity. The air conduit 30 can be made of flexible material, and an outer diameter of the air conduit 30 can be selected from a range of about 6 mm to 8 mm, an inner diameter of the air conduit 30 can be selected from a range of about 2 mm to 4 mm. When high-pressure air flow blows through the air conduit 30, the free end 32 of the air conduit 30 away from the mounting member 14 swings from side to side under the expulsive force of the high-pressure air flow, such that the air flow blows onto surfaces of the workpiece 230 to remove the contaminants adhering thereon. A pressure of the air flow can be selected from a range of about 0.6 Mpa to 0.8 Mpa, such that the high-pressure air flow causes the air conduit 30 to swing regularly. In at least one embodiment, the air conduit 30 can be a rubber hose, and a number of the air conduits 30 can be two, to correspond with a number of the mounting members 14.

In at least one embodiment, a number of the controllers 50 can be two, and each controller 50 can be located to correspond to one air conduit 30. Each controller 50 can seal the air inlet of the corresponding air conduit 30, and can turn on the corresponding air conduit 30 to enable the air flow generated by the external air source blow through the air conduit 30. Each controller 50 can include an sensing member 52 and a receiving member 54 electrically coupled to the sensing member 52. The sensing member 52 can be positioned on the conveyer 210 and adjacent to the air conduit 30. The receiving member 54 can be positioned on a surface of the supporting member 12 and away from the mounting member 14. The sensing member 52 can detect a location of the workpiece 230 transported by the conveyer 210, and can generate and transmit an information of the location to the receiving member 54. The receiving member 54 can control the air conduit 30 to make the air flow blow through or cease in the air conduit 30, according to the information. In at least one embodiment, both of the sensing member 52 and the receiving member 54 can be solenoid valves. In another embodiment, the sensing member 52 can be another sensing element, such as, but not limited to, light sensor, laser sensor, and position sensor, provided only that the location of the workpiece 230 can be detected. Similarly, the receiving member 54 can be other valves, such as, but not limited to, pneumatic valve and hydraulic valve provided only that the receiving member 45 is capable of controlling the air conduit 30 to enable the air flow to blow through or cease from blowing in the air conduit 30 according to the location information of the workpiece sent by the sensing member 52.

In assembly, the mounting member 14 can be positioned on a surface of the supporting member 12, and the air conduit 30 can be mounted on the mounting member 14. The sensing member 52 can be positioned on the conveyer 210 adjacent to the air conduit 30. The receiving member 54 can be mounted on the supporting member 12.

In operation, the mounting base 10 can be positioned above the conveyer 210, such that the air conduit 30 can be perpendicular to the conveyer 210, and the free end 32 of the air conduit 30 can face the conveyer 30. As a result, a cleaning space (not labeled) is formed between the free end 32 and the conveyer 210. The air inlet 121 of the supporting member 12 can communicate with the external air source, and the cleaning device 100 can be started. The conveyer 210 can carry the workpiece 230 out from a machining environment (not shown). The sensing members 52 can detect the workpiece 230 when the workpiece 230 is transported into the cleaning space. The sensing members 52 can generate and transmit an information of the location of the workpiece 230 to the receiving member 54. The receiving member 54 can turn on the air conduit 30 to enable the high-pressure air flow generated by the external air source blow towards the free end 32 of the air conduit 30. The free end 32 swings regularly under the expulsive force of the high-pressure air flow, and the air flow blows onto surfaces of the workpiece 230 evenly, and the contaminants adhering on the workpiece 230 are cleaned off. The conveyer 210 can keep conveying the workpiece 230. When the workpiece 230 is carried out from the cleaning space, the sensing member 52 can detect the location of the workpiece 230, and can generate and transmit an information of the location to the receiving member 54. The receiving member 54 can control the air conduit 30 to stop the air flow.

In another embodiment, the air conduit 30 can be made of other flexible material, for example, a metal hose or a corrugated hose. The free end 32 of the air conduit 30 needs to be able to swing freely when the high-pressure air flow blows through.

In another embodiment, the outer and the inner diameter of the air conduit 30 can be other dimensions, not selected from the ranges mentioned above, according to actual requirements. Similarly, the pressure of the air flow can be other value not selected from the range mentioned above. For example, when a surface of the workpiece for cleaning is a larger size, a smaller air conduit 30 and a higher pressure of the air flow can be used, such that the air conduit 30 can swing over a larger range when the air flow blows therethrough, to ensure all the contaminants can be removed. In another example, when surface of the workpiece 230 is only slightly dirty a lower pressure of the air flow can be used to remove the contaminants, such that energy can be saved.

It is believed that the present embodiments and their advantages will be understood from the foregoing description, and it will be apparent that various changes can be made thereto without departing from the scope of the embodiments or sacrificing all of its material advantages. The embodiments described herein all illustrative only, and should not be construed to limit the following claims.

What is claimed is:

1. A cleaning device comprising:
a mounting base defining an air inlet communicating with an external air source;
an air conduit mounted on the mounting base and communicating with the air inlet, the air conduit comprising a free end facing a workpiece;
a controller mounted on the mounting base and sealing the air inlet, wherein the controller is capable of turning on the air conduit to enable the external air source to generate an air flow in the air conduit blowing toward the free end of the air conduit, such that the free end of the air conduit swings to enable the air flow to blows on to surfaces of the workpiece uniformly.

2. The cleaning device of claim 1, wherein the air conduit is made of a flexible material.

3. The cleaning device of claim 1, wherein the air conduit is a rubber hose.

4. The cleaning device of claim 1, wherein the air conduit is a metal hose.

5. The cleaning device of claim 1, wherein an inner diameter of the air conduit is selected from a range of about 2 millimeter to 4 millimeter.

6. The cleaning device of claim 5, wherein an outer diameter of the air conduit is selected from a range of about 6 mm to 8 mm.

7. The cleaning device of claim 1, wherein the mounting base comprises a supporting member and a mounting member located on the supporting member; the mounting member defines an inner cavity communicating with the air inlet; the air conduit is coupled to the mounting member and communicating with the external air source through the inner cavity and the air inlet.

8. The cleaning device of claim 1, wherein the controller comprises a sensing member adjacent to the air conduit, and a receiving member located on the mounting base; the sensing member is configured to detect a location of the workpiece, and to generate and transmit an information of the location to the receiving member; the receiving member is configured to control the air conduit according to the information to make the air flow blow through.

9. The cleaning device of claim 8, wherein the sensing member and the receiving member are both solenoid valves.

10. The cleaning device of claim 1, wherein the air conduit is vertical because of the gravity and perpendicular to the workpiece.

11. A cleaning device, comprising:
a mounting base defining an air inlet communicating with an external air source;
an air conduit mounted on the mounting base and communicating with the air inlet, the air conduit comprising a free end facing a workpiece; the free end being capable of swinging when an air flow generated by the external air source blow through the air conduit.

12. The cleaning device of claim 11, further comprises a controller mounted on the mounting base and sealing the air inlet, wherein the controller is capable of turning on the air conduit, thereby enabling the external air source to generate an air flow in the air conduit blowing toward the free end, such that the free end of the air conduit swings to enable the air flow to blows onto surfaces of the workpiece uniformly.

13. The cleaning device of claim 12, wherein the controller comprises a sensing member adjacent to the air conduit, and a receiving member located on the mounting base; the sensing member is configured to detect a location of the workpiece, and to generate and transmit an information of the location to the receiving member; the receiving member is configured to control the air conduit according to the information to make the air flow blow through.

14. The cleaning device of claim 11, wherein the mounting base comprises a supporting member and a mounting member located on the supporting member; the mounting member defines an inner cavity communicating with the air inlet; the air conduit is coupled to the mounting member and communicating with the external air source through the inner cavity and the air inlet.

15. The cleaning device of claim 11, wherein the air conduit is made of a flexible material.

16. The cleaning device of claim 11, wherein the air conduit is a rubber hose.

17. The cleaning device of claim 11, wherein an inner diameter of the air conduit is selected from a range of about 2 millimeter to 4 millimeter.

18. The cleaning device of claim 17, wherein an outer diameter of the air conduit is selected from a range of about 6 millimeter to 8 millimeter.

19. The cleaning device of claim 11, wherein the air conduit is vertical because of the gravity and perpendicular to the workpiece.

20. A cleaning device, comprising:
a mounting base defining an air inlet communicating with an external air source;
an air conduit mounted on the mounting base and communicating with the air inlet, the air conduit comprising a free end facing a workpiece; the air conduit being made of a flexible material, such that the free end being capable of swinging when the external air source generates an air flow blowing through the air conduit.
